(19) United States
(12) Patent Application Publication
(10) Pub. No.: US 2024/0326638 A1
(43) Pub. Date: Oct. 3, 2024

(54) Method for managing a charging request to charge a battery of an electric vehicle

(71) Applicant: ORANGE, Issy-les-Moulineaux (FR)

(72) Inventor: Bruno Froger, CHATILLON CEDEX (FR)

(21) Appl. No.: 18/616,921

(22) Filed: Mar. 26, 2024

(30) Foreign Application Priority Data
Mar. 27, 2023 (FR) 2302899

(51) Int. Cl. B60L 53/68; B60L 53/30; B60L 53/62; B60L 53/66

(52) U.S. Cl. CPC B60L 53/68; B60L 53/305; B60L 53/62; B60L 53/66; B60L 2240/12; B60L 2240/32; B60L 2240/549

(57) ABSTRACT

A method for managing a charging request to charge a battery of an electric vehicle, carried out by a management entity able to communicate via a communication network. The method includes receiving a charging request to charge a battery of an electric vehicle, sent by a client terminal associated with the electric vehicle, followed by searching, among other client terminals associated with other electric vehicles, for client terminals able to respond to the charging request with charging offers, and sending a response including the list resulting from the searching, the response including a charging offer combining a plurality of charging offers.

### CROSS REFERENCE TO RELATED APPLICATIONS

This application claims priority to and the benefit of French patent application Non. FR 2302899, filed on Mar. 27, 2023, the content of which is incorporated herein by reference in its entirety.

### TECHNICAL FIELD

The technical field is that of the supply of electricity for electric vehicles.

More precisely, the invention relates to a method for managing a charging request to charge a battery of an electric vehicle.

Electric motor vehicles are increasingly being deployed in the context of the ecological transition. For example, the European Union has decided to ban the sale of new vehicles equipped with an internal combustion engine from 2035. The share of electric vehicles among vehicles on the road is therefore increasing sharply, and will continue to increase.

Generally speaking, these electric vehicles have an on-board battery that contains a significant amount of electric charge. As the vehicle travels, the electric motor uses the charge present in the battery. When the charge of the battery has been drained, the vehicle is no longer able to move autonomously. As a general rule, the distance able to be travelled autonomously by an electric vehicle using the charge of its battery is less than the distance able to be travelled autonomously by a combustion engine-based vehicle of a similar category. It is therefore beneficial to manage the charging of batteries of electric vehicles as efficiently as possible.

### PRIOR ART

As electric vehicles are deployed, the infrastructure needed for charging vehicle batteries also has to be deployed. This infrastructure will rely on the existing electricity distribution infrastructure: for example, it is possible to charge the battery of one's electric vehicle at home using the domestic electricity supply. However, charging terminals should also allow batteries of electric vehicles to be charged while they are on a journey, in the same way as service stations allow fuel to be supplied to combustion-powered vehicles on a journey. Since the range of electric vehicles is generally lower than that of a combustion-powered vehicle, it will likely be necessary to develop a network of charging stations denser than the equivalent network of service stations that exists for combustion-powered vehicles. This problem is compounded by the fact that charging an electric vehicle generally takes more time than filling a fuel tank of a combustion-powered vehicle. An electric vehicle that is charging will therefore occupy a dedicated space longer than a combustion-powered vehicle will in an equivalent space of a service station.

It should therefore be expected that the deployment of electric vehicles will require the deployment of significant infrastructures dedicated to charging vehicle batteries. Even in the presence of such deployment, the low range of electric vehicles compared to that of their combustion-powered equivalents will increase the risk of breakdown due to battery discharge, if compared to the risk of running out of fuel in combustion-powered vehicles.

On the other hand, electric vehicles are able, under certain conditions, to transfer some of the charge from their battery to the battery of another vehicle. This involves the presence of a suitable cable and compatibility between the discharging and charging capacities of the batteries of the two vehicles. In the event of breakdown of an electric vehicle whose battery no longer has sufficient charge to allow it to travel to a charging station, this may make it possible to assist the broken-down vehicle by transferring thereto a minimum amount of charge sufficient to reach a nearby charging station. Since the transfer of charge from one vehicle to another is limited and takes longer than in a dedicated charging station, it will preferably apply in a breakdown assistance situation.

However, there is no solution for anticipating the need for breakdown assistance or for facilitating the organization thereof when needed.

The invention aims to improve the situation.

### SUMMARY OF THE INVENTION

According to a first functional aspect, the invention relates to a method for managing a charging request to charge a battery of an electric vehicle, carried out by a management entity able to communicate via a communication network, characterized in that it comprises a step of receiving a charging request to charge a battery of an electric vehicle, sent by a client terminal associated with said electric vehicle, referred to as requesting client terminal, followed by a step of searching, among other client terminals associated with other electric vehicles, for a list of client terminals able to respond to the charging request with charging offers, and a step of sending a response including said list of client terminals able to respond to the charging request, resulting from the searching step, said response comprising a charging offer combining a plurality of charging offers.

By virtue of the invention, a user is able to request to charge the battery of their electric vehicle using a client terminal. An entity, often coincident with a computer server, will search, among other client terminals, for those that are likely to respond to this request. This charging request may be made while the user is travelling on board the electric vehicle to be charged. The charging may be carried out by transferring a jointly defined charge from a vehicle to the requesting vehicle. Some of the participating client terminals will be displayed as being able to respond to such a request in general; these will be for example garages able to provide breakdown assistance for clients in a given area. Others will respond opportunistically, without this being their primary activity, because they are able to meet the charging request in question. Users of electric vehicles travelling close to the vehicle associated with the requesting client terminal will be able to offer breakdown assistance charging thereto after having set an appointment and all of the parameters needed to carry out the charging.

The response combines a plurality of charging offers. This makes it possible to better adapt, if necessary, to route constraints or even price constraints. The combination of a plurality of charging offers allows the management entity to have greater flexibility in terms of the response offered to the client terminal requesting charging.

The response including the list resulting from the searching step will, in most embodiments, be a direct response to the requesting client terminal. In some embodiments, the response will be transmitted to the requesting client terminal using one or more intermediaries. For example, the searching step may consist in transferring the charging request to a client terminal, which terminal may or may not register on the list of client terminals able to respond to the request, and a client terminal may be the one that transmits the list resulting from the searching step to the requesting client terminal.

The method according to the invention comprises a searching step performed by the management entity, followed by a step of sending a response including a list of client terminals able to respond to the charging request and a charging offer combining a plurality of charging offers. It is clear that the management entity may continue the search after having sent a first response, and the method according to the invention also comprises sending additional responses including lists of other client terminals able to respond to the request, these other client terminals being found by the management entity as the search progresses, along with other combinations if necessary.

According to a first particular mode of implementation of the invention, the charging request comprises information about the amount of electric charge to be transferred during the charging, referred to as requested amount of charge, and, when the charging offers made by the client terminals comprise offered amounts of charge less than the requested amount of charge, the response includes a charging offer combining a plurality of charging offers that provide the requested charging.

By virtue of this mode of implementation, the combination of charging offers makes it possible to obtain a requested amount of charge. In this way, even when insufficient offers are present, the client terminal will be able to obtain a satisfactory offer.

According to another particular mode of implementation of the invention, which may be implemented as an alternative or in addition to the previous mode, the charging request comprises location information, and the searching step is based on this information.

By virtue of this mode, the search for a client terminal able to respond to the charging request is carried out in an optimized manner, taking into account the essential element, namely the location of the requester. Only client terminals able to intervene in an area close enough to the location of the requester will be searched for and selected. The location may be a future location, planned by the requesting client terminal as being where the associated electric vehicle will need to be charged taking into account parameters such as the speed of the vehicle, its route, its electric charge consumption, the amount of electric charge remaining in the battery.

According to another mode of implementation of the invention, which may be implemented as an alternative or in addition to the previous modes, the searching step comprises the management entity transmitting the received charging request to client terminals.

In this mode, the management entity broadcasts the charging request to client terminals likely to respond positively to this request. The location information received beforehand may guide the search for and therefore the selection of the client terminals to which the request is broadcast. In this way, the management entity will be able to have available charging offers that respond to the request, sent by client terminals that are able to respond to the request.

According to another mode of implementation of the invention, which may be implemented in addition to the previous modes, the method furthermore comprises the management entity receiving charging offers sent by client terminals to which the charging request has been transmitted, and the response step comprises the management entity transmitting said charging offers to the requesting client terminal.

In this mode, the charging offers are transmitted to the requesting client terminal. A search performed by the management entity makes it possible to make a selection of possibilities, among the client terminals, of those that are able to respond to the request, but it will be up to the requester to make the final choice among the possible charging offers.

According to another mode of implementation of the invention, which may be implemented as an alternative or in addition to the previous modes, the method furthermore comprises the management entity receiving information representative of a choice made by the requesting client terminal from among the charging offers transmitted by the management entity.

By virtue of this mode, the choice that is made is transmitted to the entities that have made charging offers, so that the charging is ultimately able to be carried out by the owner responsible for the client terminal that made the chosen charging offer. The management entity may transmit the information representative of a choice to all of the other client terminals, in particular to those that made a charging offer.

According to another mode of implementation of the invention, which may be implemented as an alternative or in addition to the previous modes, a charging offer comprises one or more data chosen from:
a) the coordinates of a location where the charging is to be carried out;
b) a time slot during which the charging is to be carried out;
c) an amount of electric charge to be transferred during the charging;
d) a datum representative of a recompense for carrying out the charging.

By virtue of this mode of implementation, client terminals wishing to respond positively to the charging request transmit information relating to their charging offer. It is thus possible for the users of the client terminals that make charging offers to make these sufficiently precise to inform the choice that will be made by the client terminal that made the charging request. The important information to be given includes the location where the charging is to be carried out. A time slot may also be offered. Other important information is the amount of electric charge that is offered, which may be expressed in watts or else as a percentage of charging of a battery, along with a recompense that will be requested for carrying out the charging, that is to say a price for example.

According to another mode of implementation of the invention, which may be implemented as an alternative or in addition to the previous modes, the charging request comprises information about the amount of electric charge to be transferred during the charging, referred to as requested amount of charge, and, if the charging offers sent by the client terminals comprise offered amounts of charge less than the requested amount of charge, the management entity will transmit, to the requesting client terminal, a charging offer combining a plurality of sent charging offers.

By virtue of this embodiment, the management entity is able to construct a charging offer combining a plurality of charging offers sent by client terminals so that the amount of charge obtained at the end of the multiple charging operations is as close as possible to the requested amount. In this mode, the management entity plays the role of an organizer that will make it possible to meet the need of the requesting client terminal based on partial offers, whereas, in the other modes, the management entity mainly plays the role of an intermediary.

According to a second functional aspect, the invention relates to a method for obtaining charging of a battery of an electric vehicle, carried out by a client terminal associated with said electric vehicle, referred to as requesting client terminal, the requesting client terminal being able to communicate via a communication network, characterized in that it comprises the requesting client terminal transmitting a charging request to charge a battery of said electric vehicle to a management entity via the communication network, followed by the requesting client terminal receiving a response including a list of client terminals able to respond to the charging request with charging offers, said response comprising a charging offer combining a plurality of charging offers.

By virtue of this other aspect of the invention, the client terminal associated with an electric vehicle is able to transmit a charging request to a management entity. The search carried out by the management entity will enable the client terminal to receive one or more responses including a list of client terminals able to respond to the request. This list may be empty, if no client terminal was found by the management entity. Multiple responses may follow one another with multiple lists including client terminals able to respond to the request. In addition, the obtaining method also comprises the client terminal receiving charging offers. The client terminal will be able to make a choice among the charging offers and transmit information representative of this choice to the management entity.

The charging offer made by the management entity combines a plurality of charging offers. This combination makes it possible to obtain solutions that comply with the constraints of the requester, for example constraints in terms of price, or in terms of route, and finally if the individual charging offers do not make it possible to obtain the amount of charge requested by the client terminal.

The charging request is transmitted to a management entity. In the vast majority of embodiments, the request will be transmitted directly from the requesting client terminal to the management entity. However, in some embodiments, the request may be sent to other client terminals known to the requesting client terminal. A list of client terminals able to respond to the request may be transmitted step by step and finally sent to the management entity whose role, in this embodiment, will mainly be that of keeping track of the offers. In the extreme case, the charging request may be transmitted step by step between client terminals without the involvement of a management entity.

According to a first mode of implementation of this aspect of the invention, the obtaining method furthermore comprises the requesting client terminal sending, to the management entity, information representative of a choice of client terminal from the list included in the response.

By virtue of this mode of implementation, the requesting client terminal sends back, to the management entity, a choice from among the client terminals able to respond to the request. Information detailing the charging offers could have been transmitted to the requesting client terminal, such as an offer of a location where the charging is to be carried out, a time slot, an amount of electric charge to be transferred, a recompense to be given for carrying out the charging, technical compatibility information, and any other information useful for actually carrying out the charging. The choice may then be transmitted to the client terminals that were found to be able to respond to the charging request or that made charging offers.

According to a second mode of implementation of this second aspect of the invention, the list of client terminals able to respond to the request included in the response comprises contact information for the client terminals able to respond, and the method furthermore comprises the requesting client terminal sending a message to one of the client terminals able to respond using the contact information for this client terminal.

By virtue of this embodiment, the role of the management entity is minimized. Once the searching step allows the management entity to offer client terminals able to respond to the charging request, it is the requesting client terminal itself that will establish contact, without an intermediary, with client terminals able to respond to its request. This mode makes it possible to obtain a response more quickly, by directly contacting a client terminal able to respond to the request. As the client terminals procure one another's contact information, they are subsequently able to contact one another directly without the involvement of the management entity, except possibly in a transaction archiving role.

According to a third mode of implementation of this second aspect of the invention, the charging request is transmitted by the requesting client terminal after a calculation that takes into account at least one parameter chosen from the following list:
a) the location of the electric vehicle with which the requesting client terminal is associated;
b) the direction and the speed of movement of said electric vehicle;
c) the current charge of the battery;
d) the consumption of the electric vehicle;
e) the presence of battery charging points near the location of the electric vehicle with which the requesting client terminal is associated in its direction of movement.

The advantage of this mode of implementation is that it allows a precise calculation using the maximum number of possible parameters to define the charging need of the electric vehicle. The result of this calculation may provide information about the location at which the charging will be desirable, taking into account the planned movement of the electric vehicle. Such information will make it possible to facilitate the search for client terminals able to respond to the request, along with the search for charging offers that these client terminals may make.

According to a first hardware aspect, the invention relates to a management entity equipped with communication means, comprising a module for receiving battery charging requests from client terminals, a module for searching for client terminals able to respond to a received charging request with charging offers, and a response module able to send a response including a list of client terminals able to respond to a request, said response comprising a charging offer combining a plurality of charging offers, the management entity being able to carry out a management method according to the invention.

According to a second hardware aspect, the invention relates to a client terminal equipped with communication means, comprising a module for transmitting a battery charging request to a management entity and a module for receiving a response including a list of client terminals able to respond to the charging request with charging offers, said response comprising a charging offer combining a plurality of charging offers, the client terminal being able to carry out an obtaining method according to the invention.

According to one embodiment of this second hardware aspect, the invention relates to an electric motor vehicle comprising a client terminal according to the invention.

According to another embodiment of this second hardware aspect, the invention relates to a mobile terminal according to the invention.

According to another hardware aspect, the invention relates to a computer program able to be implemented by a management entity, the program comprising code instructions that, when it is executed by a processor, carry out the steps of the management method defined above.

According to another hardware aspect, the invention relates to a computer program able to be implemented by a client terminal, the program comprising code instructions that, when it is executed by a processor, carry out the steps of the obtaining method defined above.

Finally, according to another hardware aspect, the invention relates to data media storing computer programs comprising sequences of instructions for implementing the management method and the obtaining method defined above.

The data media may be any entity or device capable of storing the programs. For example, the media may comprise a storage means, such as a ROM, for example a CD-ROM or a microelectronic circuit ROM, or else a magnetic recording means, such as a hard disk. On the other hand, the media may be transmissible media such as an electrical or optical signal, which may be routed via an electrical or optical cable, by radio or by other means. The programs according to the invention may in particular be downloaded from an Internet network. As an alternative, the information medium may be an integrated circuit into which the program is incorporated, the circuit being designed to execute or to be used in the execution of the method in question.

### BRIEF DESCRIPTION OF THE FIGURES

The invention will be better understood on reading the following description, which is given by way of example and with reference to the appended drawings, in which:

FIG. 1 shows a client terminal transmitting a charging request to a management entity.

FIG. 2 illustrates one example of steps implemented in the context of one embodiment of the invention.

### DETAILED DESCRIPTION

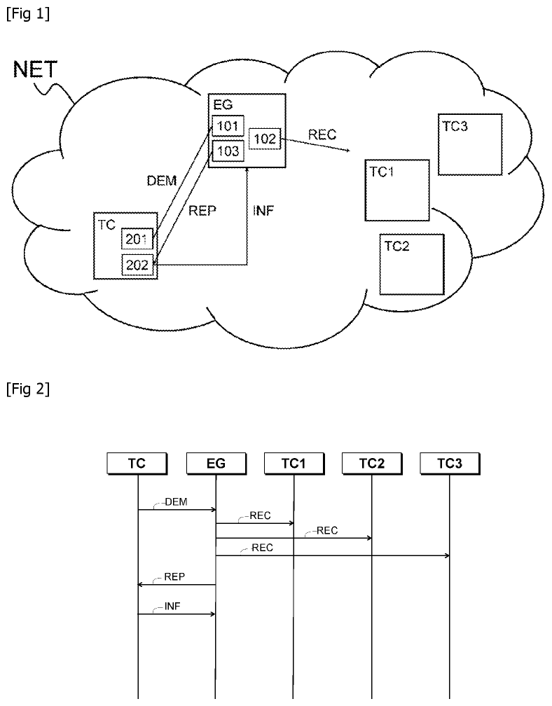

FIG. 1 shows a client terminal TC and a management entity EG. These two elements are able to communicate with one another or with other client terminals TC1, TC2, TC3 by way of a communication network NET.

The management entity EG has the hardware architecture of a conventional computer. It comprises in particular a processor, a random access memory of RAM type and a read-only memory such as a flash or ROM memory (not shown in the figure), along with input/output devices such as keyboards and/or screens (not shown in the figure). The management entity EG may run in a hardware server accessible via the communication network NET or else run in a cloud computing architecture.

The client terminal TC also has the hardware architecture of a conventional computer, comprising in particular a processor, memory elements and input/output devices, which are not shown in the figure. The client terminal TC may for example be embedded directly in an electric vehicle and run on a processor integrated into the vehicle. The client terminal TC may also be a laptop computer or a mobile terminal such as a smartphone that is able to communicate with users via interfaces offered in an electric vehicle, such as Wi-Fi or Bluetooth interfaces, or else through its own interfaces. The client terminal will embed a program that will carry out the steps of the method, which program is written in a programming language designed to run in the client terminal, depending on the operating system thereof. When the client terminal is embedded in an electric vehicle, it is associated directly with this electric vehicle. When the client terminal is a mobile terminal, a smartphone or a laptop computer, it may be associated with an electric vehicle using a pairing method that is well known in the prior art. When the electric vehicle is travelling, the client terminal, such as a smartphone associated with the electric vehicle, may have available information such as the level of charge of the battery, or the location, the speed and direction of the vehicle via communication interfaces of the electric vehicle that are not shown in FIG. 1.

By virtue of these embodiments, the client terminal TC may make a charging request DEM to charge the battery en route in an electric vehicle, in order to obtain charging so as to avoid the vehicle breaking down. The client terminal TC may also be a conventional computer, and the charging request DEM will then be used in a travel planning context to provide for a step for charging a battery at a planned place and time.

The other client terminals TC1, TC2, TC3 have the same hardware architecture as the client terminal TC. In the majority of embodiments, the client terminal TC and the other client terminals TC1, TC2, TC3 are in fact identical, and will be able to perform different functions according to the needs of their users. In one case, software clients such as TC are used to request DEM electric vehicle battery charging, whereas, in other cases, client terminals such as TC1, TC2, TC3 will offer to respond to this request. However, the same client terminal TC may also respond to a charging request DEM from another client terminal TC1, TC2, TC3 in another context. In this case, one and the same client terminal TC will be the one requesting charging at one time and responding to a charging request at another time.

In some embodiments, the other client terminals TC1, TC2, TC3 that will respond to the request DEM are not associated with an electric vehicle. These may be client terminals used by breakdown assistance providers who will respond to the charging request DEM by going out to the breakdown assistance location to carry out charging with a dedicated battery, which is not that of an electric vehicle, but which is dedicated to breakdown assistance. These may also be client terminals used by individuals who are able to offer charging at their home, or elsewhere, by giving access to a charging terminal, or even just to a power outlet, to carry out the charging.

In general, the requesting client terminal TC sends its request to the management entity EG, which plays the role of an intermediary between the requesting client terminal TC and the other client terminals TC1, TC2, TC3, which include those able to respond to the request DEM. However, in other embodiments of the invention, the client terminals TC, TC1, TC2, TC3 may communicate directly with one another, and the role of the management entity may then be limited to that of setting up initial contact or recording transactions.

The management entity EG comprises a module 101 for receiving battery charging requests DEM.

The management entity EG comprises a module 102 for searching for client terminals TC1, TC2, TC3 able to respond to a battery charging request.

The management entity EG comprises a module 103 for responding REP to a battery charging request DEM.

The client terminal TC comprises a module 201 for transmitting a battery charging request DEM.

The client terminal TC comprises a module 202 for receiving a response REP including a list of client terminals able to respond to the request.

The management entity EG communicates with the client terminal TC and the other client terminals TC1, TC2, TC3 via the communication network NET. In general, this communication network NET is the Internet, to which all of the participants in the method for requesting charging and in the obtaining method are connected. The client terminals TC and TC1, TC2, TC3 are able to connect to the communication network NET while they are moving using mobile telecommunications technologies such as 3G, 4G, 5G or the like. The management entity EG, for its part, will generally not be mobile, but will indeed be connected to the same communication network NET. In some embodiments, the method for requesting charging and the obtaining method may be implemented for a private set of client terminals TC. In this case, the network NET may be a private network, which may be dedicated to implementing these methods. For example, the network NET may be a slice of a 5G telecommunications network, to which slice only client terminals participating in the method for requesting charging and the obtaining method will have access. This ensures maximum security of the communications for carrying out the methods. Such a slice of a 5G telecommunications network may for example be operated by a motor vehicle manufacturer, and in this case, the method for managing the request for charging will be implemented solely between a management entity EG and client terminals TC, TC1, TC2, TC3 associated with electric vehicles of the manufacturer in question. The management method will then be a mutual aid between users of electric vehicles of one and the same manufacturer who will be prepared to share electric charge for breakdown assistance purposes.

In some embodiments, the management method according to the invention comprises registering client terminals TC1, TC2, TC3 with the management entity EG. This registration consists in showing as being available to respond to battery charging requests DEM at a later time. The registration enables the management entity EG to save a whole set of parameters concerning charging requests to which the client terminals TC1, TC2, TC3 are able to respond. In some embodiments, the participating clients TC1, TC2, TC3 will have to specify the battery models that they are able to charge in order to act on requests. In other embodiments, the participating clients TC1, TC2, TC3 will specify geographic areas or time periods for which they are prepared to respond to requests. Another possible parameter able to be provided upon registration is the recompense that the user of a registered client terminal TC1, TC2 or TC3 will request to respond to a charging request. This recompense may for example be a price for the amount of electric charge that will be provided in response to the charging request. The price for the charge may be expressed for a given amount of watts or for a given battery charging percentage. In some embodiments, registering the client terminals TC1, TC2, TC3 will comprise providing authorization so that the management entity EG is able to have available real-time information provided by the client terminals TC1, TC2, TC3, such as the location of the electric vehicles associated with the client terminals TC1, TC2, TC3 or the amount of electric charge contained in the one or more batteries of the associated electric vehicles. This information may be used by the management entity EG during the searching step REC.

The management method according to the invention then comprises the management entity receiving a charging request DEM to charge a battery of an electric vehicle, the request DEM being sent by the client terminal TC. The client terminal TC may have registered beforehand with the management entity EG as a participant in the method, but this is not the case in some embodiments.

In some embodiments, the charging request DEM will comprise technical information relating to the battery that is to be charged. Such technical information may be for example the model of the battery or of the electric vehicle that is to be charged, or the model of a charging cable compatible with the electric vehicle.

In other embodiments, the charging request DEM comprises location information. This location information may be for example an area in which the user of the client terminal TC wants the charging to take place. This location information may also be supplemented with time information specifying the period when the charging is desired.

In other embodiments, the charging request DEM comprises information relating to the amount of electric charge desired to be transferred during the charging. This information may be expressed in watts or as a battery charge percentage. Desired price information may also be contained in the charging request DEM.

The management method according to the invention then comprises a step REC of searching, among the client terminals TC1, TC2, TC3, for those that are able to respond to the request DEM.

The searching step REC performed by the management entity EG may be carried out using only the information recorded upon registration of the client terminals TC1, TC2, TC3. For example, a client terminal may have advertised that it is available at any time in a given geographical area to respond to charging requests for a given battery model or vehicle model. If the criteria of the charging request DEM match, the management entity EG may conclude that this client terminal is able to respond to the request DEM, and it will therefore be among the clients able to respond to the request DEM that will have been found by the searching step REC. In some embodiments, the registered client terminals TC1, TC2, TC3 regularly send back location information to the management entity EG, and the management entity EG uses this location information in the searching step REC. Another type of information that may be used by the management entity EG is the amount of charge present in the battery of the electric vehicles associated with the client terminals TC1, TC2, TC3.

In another embodiment, the searching step REC will consist, for the management entity EG, in transmitting the charging request DEM to the participating client terminals TC1, TC2, TC3. The management entity EG may combine these two embodiments. The information recorded about the client terminals TC1, TC2, TC3 may enable the management entity EG to determine which clients are most likely to respond positively to the request DEM, and the management entity EG will transmit the charging request DEM only to a subset of the client terminals TC1, TC2, TC3, which subset is obtained by choosing those most likely to respond positively to the request DEM. The location information in relation to the client terminals TC1, TC2, TC3, which is sent back regularly to the management entity EG, may be used to determine which clients are most likely to respond to the request DEM.

The management method according to the invention then comprises a response step REP of the management entity responding to the requesting client terminal TC depending on the result of the searching step REC. This response REP includes a list of client terminals able to respond to the request DEM. The list may be empty if the searching step REC was not successful.

In some embodiments, the searching step REC will continue after the response REP has been sent. The management entity EG may then send additional responses REP, with new lists including additional client terminals able to respond to the request DEM.

In some embodiments, the response REP comprises contact information with the client terminals able to respond to the request DEM, and the requesting client terminal TC may enter directly into contact with one of the client terminals able to respond to the request DEM in order to finalize obtaining charging.

In some embodiments, the method comprises an additional step of the management entity EG receiving charging offers sent by client terminals TC1, TC2, TC3 to which the charging request DEM was transmitted in the searching step REC, and the response step REP then comprises the management entity EG transmitting these charging offers to the client terminal TC.

In other embodiments, the management entity EG will have made a choice from among the charging offers obtained following the searching step REC and will transmit this choice directly to the requesting client terminal TC without having transmitted the request DEM to the participating client terminals TC1, TC2, TC3 because the searching step REC had available enough information obtained upon registration to make a choice without having to transmit the request.

In some embodiments, the participating client terminals TC1, TC2, TC3 that are able to respond positively to the charging request DEM will make charging offers directly to the client terminal TC that made the charging request DEM. The requesting client terminal TC will then receive the charging offers directly. Indeed, the client terminals TC and TC1, TC2, TC3 may communicate directly with one another via the communication network NET, without having to go via the management entity EG. The battery charging request DEM must then comprise a means for directly connecting the client terminal TC, such as a URL (Uniform Resource Locator) address for example, or a postal or email address or a telephone number.

In some embodiments, the charging offers comprise multiple information in order to be able to realize the offer in question. In some embodiments, the offer comprises an offer of a location to carry out the charging. The offer may also comprise time information for specifying the time when the charging may be carried out. This time information may be an appointment date and time from which the charging may be carried out, or else a time range, or else a date beyond which the charging will no longer be possible.

This information makes it possible to prepare an appointment between the vehicle with which the client terminal TC requesting charging is associated and the user of the client terminal TC1, TC2, TC3 offering to carry out charging. Once the appointment has been defined, the charging may take place using a battery that the user of the participating client terminal TC1, TC2, TC3 will have brought to the appointment location, which battery will be able to be discharged so as to provide charging for the battery of the electric vehicle to which the client terminal TC requesting charging is attached. In some embodiments, the user offering to respond to the charging request is a breakdown assistance provider, who will use a dedicated breakdown assistance battery to carry out the requested charging. In most embodiments of the invention, the participating client terminal TC1, TC2, TC3 is itself associated with an electric vehicle, and the charging will take place from the battery of said electric vehicle. The participating client terminals TC1, TC2, TC3 are then ad-hoc breakdown assistance providers able to provide an ad-hoc service for the user of the client terminal TC requesting battery charging for their electric vehicle by discharging the battery of their own electric vehicle associated with the client terminal TC1, TC2, TC3. These ad-hoc breakdown assistance providers may for example be drivers of vehicles travelling on the same portion of road or motorway as the electric vehicle associated with the client terminal TC requesting charging. The vehicle requesting charging may for example need limited charging in order to reach a complete charging station out of its current range, and the management entity EG will transmit the charging request sent by the client terminal TC to the client terminals TC1, TC2, TC3 of nearby vehicles.

The ad-hoc breakdown assistance providers may also be drivers of electric vehicles of the same manufacturer as the electric vehicle associated with the requesting client terminal TC, and the method may be organized by the manufacturer of the electric vehicles in question. The benefit of this embodiment is that of ensuring that there are no compatibility problems between electric vehicles, since they originate from the same manufacturer.

The ad-hoc breakdown assistance providers may also be individuals who have available a charging facility at a specific place, that is to say a power outlet that they are able to make available. The location of the appointment will then necessarily be the location of the power outlet that is made available.

In some embodiments, the charging offer comprises an offer for an amount of electric charge to be transferred during the charging. By virtue of this information, the client terminal TC requesting charging will be able to know whether the charging offers will allow it to meet its need, and for example, after the charging, to reach the destination of the electric vehicle with which the client terminal TC is associated. The management entity EG may combine charging offers that offer insufficient amounts of electric charge in order to carry out successive charging operations that will make it possible to respond to the need expressed in the request DEM.

In some embodiments, the charging offer comprises a datum representative of a recompense for carrying out the charging. This recompense may be a price, for example. By virtue of this information, the user of the client terminal TC may choose between the charging offers made to them. The choice may also be made automatically by the client terminal TC, for example by choosing the charging offer that has the lowest price, once more decisive criteria regarding the location where the charging is to take place, time and amount of electric charge offered are met. The management entity EG may also take into account the recompense requested for carrying out the charging in order to establish the list included in the response REP. The management entity EG may thus favour client terminals that request the lowest recompense for carrying out the charging, the other conditions being similar.

The invention also relates to a method for obtaining charging of a battery of an electric vehicle, carried out by a client terminal TC associated with said electric vehicle. As seen above, the client terminal TC is able to communicate with the management entity EG via the communication network NET. In some embodiments, the client terminal TC is also able to communicate directly with other client terminals TC1, TC2, TC3 via the communication network NET without going via the management entity EG.

In the obtaining method, the client terminal TC transmits a charging request DEM to charge a battery of the electric vehicle to which the client terminal TC is attached to the management entity EG via the communication network NET. The request DEM may comprise, depending on the embodiments, information such as location information, time indications, indications relating to the model of the vehicle and the battery to be charged, indications relating to the amount of electric charge requested, and the financial recompense able to be made.

In some embodiments, the obtaining method furthermore comprises the client terminal TC transmitting, to the management entity EG, information INF representative of a choice from among the charging offers received by the client terminal TC. The information INF may then be transmitted to the participating client terminals TC1, TC2, TC3.

It is also possible for the requesting client terminal TC to use contact information present in the list of client terminals able to respond included in the response REP in order to directly contact a client terminal that will be able to carry out the charging. This contact information may be telephone numbers, email addresses, URL (Uniform Resource Locator) addresses.

The information INF will make it possible to finalize the appointment between the electric vehicle with which the client terminal TC is associated and the user of the client terminals TC1, TC2, TC3 whose charging offer was chosen by the client terminal TC. This appointment will make it possible to carry out the charging requested DEM by the client terminal TC, and will therefore allow the method for obtaining charging to terminate. In some embodiments, once the charging has been carried out, the method furthermore comprises a payment operation carried out by the client terminal TC via the management entity EG. The management entity EG may retain a commission from this payment. In some embodiments, the client terminal TC enters directly into contact with the client terminal from among the other client terminals TC1, TC2, TC3 that has been chosen to carry out the charging, and the payment will be made directly from the client terminal TC to the other client terminal.

In some embodiments, the client terminal TC performs a calculation before sending its charging request DEM. This calculation takes into account at least one parameter chosen from the following list:
a) the location of the electric vehicle to which the client terminal TC is attached;
b) the direction and the speed of movement of said electric vehicle;
c) the current charge of the battery;
d) the consumption of the electric vehicle;
e) the presence of battery charging points near the location of the electric vehicle to which the client terminal TC is attached in its direction of movement.

This calculation may also be carried out outside the client terminal TC, for example by calculation resources called on by the client terminal TC, or else by the management entity EG itself, which, in this case, will plan the route of the electric vehicle associated with the client terminal TC. This calculation enables the client terminal TC to predict, as accurately as possible, when the battery of the electric vehicle will be drained during its journey, and whether the absence of charging points in the direction of movement justifies implementing the obtaining method. This calculation makes it possible to determine location information, which may be integrated into the charging request DEM. This location information then represents the area in which the client terminal TC wishes to carry out battery charging.

FIG. 2, for its part, shows one example of an exchange of messages when implementing the method for managing a charging request and the method for obtaining charging according to the invention.

The client terminal TC is associated with an electric vehicle. It is able to communicate via the communication network NET. The client terminal TC is able to carry out calculations that allow it to anticipate whether the electric vehicle to which it is attached will need battery charging, and in which area. The client terminal TC will then transmit a battery charging request DEM to the management entity EG. The request DEM will comprise all of the information needed to ascertain how to satisfy it, such as for example location information, time information, technical information about the vehicle model or battery model, information relating to the requested charge, information relating to the proposed payment for the charge, or any other useful information.

The management entity EG will carry out a searching step REC. This step may consist in querying client terminals TC1, TC2, TC3, as indicated in FIG. 2. However, the searching step REC will also be carried out by the management entity EG by selecting client terminals able to respond to the request DEM from among the client terminals TC1, TC2, TC3 without querying them, using information provided at the time that they register or using location information in relation to the client terminals TC1, TC2, TC3, which is provided regularly to the management entity EG. The searching step REC will, in general, combine a step of the management entity EG selecting, on the basis of the information available thereto, client terminals among those TC1, TC2, TC3 that are likely to respond positively to the request DEM, which selection step is followed by a query to these selected client terminals as to whether they are prepared to respond positively to the request DEM.

The management entity EG, following the searching step REC, will provide one or more responses REP to the request DEM from the client terminal TC. This or these responses REP comprise at least one list of client terminals able to respond to the request DEM and, in general, all of the information needed for the client terminal TC to be able to obtain charging of the battery of the electric vehicle with which it is associated. FIG. 2 shows one implementation of the method, in which a single response REP is sent. In particular, a response REP may comprise location information, time information, technical information about the proposed charging, and information about the requested recompense. The management entity EG may, in some embodiments, make a selection and offer only one client terminal able to respond to the request DEM and only one charging possibility for the requesting client terminal TC. In other embodiments, the management entity EG sends multiple possibilities to the requesting client terminal TC in the response REP, and the client terminal TC will then transmit information INF relating to its choice to the management entity EG. The management entity EG may send multiple responses REP as the search REC continues. In some embodiments, the client terminal TC directly contacts the client terminal chosen to respond to the request DEM, and in other embodiments, the management entity EG retains its role as a communication intermediary between the client terminal TC and the client terminal chosen to respond to the request DEM.

Once the choice has been made, the appointment will make it possible to carry out the actual charging of the battery as requested DEM by the client terminal TC. The charging in question may take place at any place where the electric vehicle to which the requesting client terminal TC is attached is able to park, and not at a dedicated charging point like a service station dispensing fuel. The party who will carry out the charging may be a dedicated breakdown assistance provider, using a client terminal registered with the management entity EG, or else a driver of another electric vehicle, who may also be registered with the management entity EG, taking a journey close to that of the vehicle to which the client terminal TC is attached and willing to provide ad-hoc breakdown assistance for said vehicle. It may also be an individual willing to provide breakdown assistance for a vehicle at their home. The charging itself consists in transferring an amount of electric charge from a dedicated battery or else from a battery of an electric vehicle or else from a power outlet. The charging may entail a payment and, in some embodiments, the management entity EG acts as an intermediary for making the payment, or else acts as a guarantee for the payment, and may take a commission therefrom.

Lastly, it should be pointed out here that, in the present text, the term “module” may correspond equally to a software component or to a hardware component or to a set of software and hardware components, a software component itself corresponding to one or more computer programs or subroutines or, more generally, to any element of a program able to implement a function or a set of functions such as described for the modules in question. In the same way, a hardware component corresponds to any element of a hardware assembly that is able to implement a function or a set of functions for the module in question (integrated circuit, chip card, memory card etc.).

1. A management method for managing a charging request to charge a battery of an electric vehicle, carried out by a management entity able to communicate via a communication network, wherein the method comprises:
receiving the charging request to charge the battery of the electric vehicle, sent by a client terminal associated with said electric vehicle, referred to as requesting client terminal;
after receiving the charging request, searching, among other client terminals associated with other electric vehicles, for a list of client terminals able to respond to the charging request with charging offers; and
sending a response including said list of client terminals able to respond to the charging request, resulting from the searching, said response comprising a charging offer combining a plurality of the charging offers.

2. The management method according to claim 1, wherein the charging request comprises information about an amount of electric charge to be transferred during the charging, referred to as requested amount of charge, and wherein, in response to the charging offers made by the client terminals comprising offered amounts of charge less than the requested amount of charge, the response includes a charging offer combining a plurality of charging offers that provide the requested charging.

3. The management method according to claim 1, wherein the charging request comprises location information and the searching is based on the location information.

4. The management method according to claim 1, wherein the searching comprises the management entity transmitting the received charging request to the other client terminals.

5. The management method according to claim 1, wherein the method furthermore comprises the management entity (EG) receiving information (INF) representative of a choice made by the requesting client terminal (TC) from among the charging offers transmitted by the management entity (EG).

6. The management method according to claim 1, wherein each of the charging offers comprises one or more data chosen from:
a. coordinates of a location where the charging is to be carried out;
b. a time slot during which the charging is to be carried out;
C. an amount of electric charge to be transferred during the charging;
d. a datum representative of a recompense for carry out the charging.

7. An obtaining method for obtaining charging of a battery of an electric vehicle, carried out by a client terminal associated with said electric vehicle, referred to as a requesting client terminal, the requesting client terminal being able to communicate via a communication network, wherein the method comprises:
the requesting client terminal transmitting a charging request to charge the battery of said electric vehicle to a management entity via the communication network; and
after transmitting the charging request, receiving a response including a list of other client terminals able to respond to the charging request with charging offers, said response comprising a charging offer combining a plurality of the charging offers.

8. The obtaining method according to claim 7, wherein the method furthermore comprises the requesting client terminal sending, to the management entity, information representative of a choice of client terminal from the list included in the received response.

9. The obtaining method according to claim 7, wherein the list of client terminals able to respond to the request included in the response comprises contact information for the client terminals able to respond, and wherein the method furthermore comprises the requesting client terminal sending a message to one of the client terminals able to respond using the contact information for this client terminal.

10. The obtaining method according to claim 7, wherein the charging request is transmitted by the requesting client terminal after a calculation that takes into account at least one parameter chosen from the following list:
a. a location of the electric vehicle with which the requesting client terminal is associated;
b. a direction and a speed of movement of said electric vehicle;
c. a current charge of the battery;
d. a consumption of the electric vehicle;
e. a presence of battery charging points near the location of the electric vehicle with which the requesting client terminal is associated in a direction of movement of the requesting client terminal.

11. A management entity able to communicate via a communication network, comprising:
at least one processor; and
at least one non-transitory computer readable medium comprising instructions stored thereon which when executed by the at least one processor configure the management entity to execute a method for managing a charging request to charge a battery of an electric vehicle, the method comprising:
receiving the charging request to charge the battery of the electric vehicle, sent by a client terminal associated with said electric vehicle, referred to as requesting client terminal;
after receiving the charging request, searching, among other client terminals associated with other electric vehicles, for a list of client terminals able to respond to the charging request with charging offers; and
sending a response including said list of client terminals able to respond to the charging request, resulting from the searching, said response comprising a charging offer combining a plurality of the charging offers.

12. A requesting client terminal able to communicate via a communication network, comprising:
at least one processor; and
at least one non-transitory computer readable medium comprising instructions stored thereon which when executed by the at least one processor configure the requesting client terminal to execute a method for obtaining charging of a battery of an electric vehicle associated with the requesting client terminal, the method comprising:
the requesting client terminal transmitting a charging request to charge the battery of said electric vehicle to a management entity via the communication network; and
after transmitting the charging request, receiving a response including a list of other client terminals able to respond to the charging request with charging offers, said response comprising a charging offer combining a plurality of the charging offers.

13. An electric motor vehicle comprising the requesting client terminal according to claim 12.

14. The requesting client terminal according to claim 12, wherein the requesting client terminal is a mobile terminal.

15. A non-transitory computer readable medium comprising a computer program stored thereon comprising code instructions that, when executed by a processor of a management entity able to communicate via a communication network, configure the management entity to execute a method for managing a charging request to charge a battery of an electric vehicle, wherein the method comprises:
receiving the charging request to charge the battery of the electric vehicle, sent by a client terminal associated with said electric vehicle, referred to as requesting client terminal;
after receiving the charging request, searching, among other client terminals associated with other electric vehicles, for a list of client terminals able to respond to the charging request with charging offers; and
sending a response including said list of client terminals able to respond to the charging request, resulting from the searching, said response comprising a charging offer combining a plurality of the charging offers.

16. A non-transitory computer readable medium comprising a computer program comprising code instructions that, when executed by a processor of a requesting client terminal able to communicate via a communication network, configure the requesting client terminal to execute a method for obtaining charging of a battery of an electric vehicle associated with the requesting client terminal, wherein the method comprises:
the requesting client terminal transmitting a charging request to charge the battery of said electric vehicle to a management entity via the communication network; and
after transmitting the charging request, receiving a response including a list of other client terminals able to respond to the charging request with charging offers, said response comprising a charging offer combining a plurality of the charging offers.
